(19) United States
(12) Patent Application Publication
(10) Pub. No.: US 2017/0264991 A1
(43) Pub. Date: Sep. 14, 2017

(54) HEADPHONE OR EARPHONE ASSEMBLY HAVING A PIVOTABLE USB CHARGING CONNECTOR INTEGRATED INTO A HOUSING THEREOF

(71) Applicant: VOXX International Corporation, Hauppauge, NY (US)

(72) Inventors: Edward Robert Horst, Carmel, IN (US); Yiqi W. Woodling, Carmel, IN (US); John Anthony Andrews, Indianapolis, IN (US)

(21) Appl. No.: 15/454,419

(22) Filed: Mar. 9, 2017

Related U.S. Application Data
(60) Provisional application No. 62/306,843, filed on Mar. 11, 2016.

(51) Int. Cl. H04R 1/10; H01R 13/60; H02J 7/00; H01R 24/60

(52) U.S. Cl. CPC H04R 1/1041; H04R 1/1016; H01R 24/60; H01R 13/60; H02J 7/0045; H02J 7/0027; H04R 2420/07; H01R 2107/00

(57) ABSTRACT

Wireless earphones or headphones include a control unit having a housing which contains electronic circuitry, and exposed push button switches mounted on the housing. The control unit has a pivotable and foldable male connector plug in the form of a micro or mini USB connector. The plug may be pivoted outwardly, away from the control unit, and unfolded to conform to the shape of a standard micro or mini USB plug. The advantage of such a design is that there are no extra cables required for charging internal battery of the earphones or headphones. Rather, the male connector of the control unit, which is exposed when pivoted away from the control unit and useable when unfolded, may be plugged directly into a laptop computer or other source of power having a compatible micro or mini USB female connector, without the need for a cable extending between the two devices.

### CROSS-REFERENCE TO RELATED APPLICATIONS

This application is related to U.S. Provisional Patent Application Ser. No. 62/306,843, filed on Mar. 11, 2016, and entitled “Headphone or Earphone Assembly Having a Pivotable USB Charging Connector Integrated into a Microphone Housing Thereof”, the disclosure of which is hereby incorporated by reference and on which priority is hereby claimed.

### BACKGROUND OF THE INVENTION

Field of the Invention

The present invention relates to headphones and earphones (commonly referred to “earbuds”), and particularly relates to headphones and earphones that are wireless and require charging.

Description of the Prior Art

Earphones and headphones which wirelessly connect to a mobile or other compatible device have come on the market in recent years. Many of the earphones and headphones pair with most any Bluetooth-enabled device. However, such wireless earphones and headphones differ from standard earphones and headphones in that the wireless devices are powered by a battery that must be periodically re-charged.

With conventional wireless earphones and headphones, a micro USB female connector is provided on the earphone housing and headphone housing, or in a control unit or microphone housing connected to the earphones or headphones. A charging cable, having a compatible micro USB male connector, is provided with the wireless earphones or headphones to charge the batteries therein. Thus, a user of the wireless earphones and headphones must keep and store this separate USB charging cable.

The present invention eliminates the need for a separate USB charging cable, and further provides a housing for the microphone or control unit of the earphones or headphones having an integrated, pivotable male USB connector, which makes charging of the internal battery even easier for the user.

### OBJECTS AND SUMMARY OF THE INVENTION

It is an object of the present invention to provide a wireless earphone or headphone assembly that eliminates the need for a separate USB charging cable.

It is another object of the present invention to provide a wireless earphone or headphone assembly that includes a microphone housing, or a housing for a control unit for the earphones or headphones, on which is pivotally mounted a charging male connector for charging the internal battery thereof.

It is still another object of the present invention to provide wireless earbuds and headphones which overcome the disadvantages of conventional wireless earbuds and headphones.

In accordance with one form of the present invention, wireless earphones or headphones include a control unit, or microphone, having a housing which contains a printed circuit board having electronic circuitry thereon, exposed switches (e.g., push button switches) mounted on the housing and exposed on a surface thereof for activation by a user of the earphones or headphones, a light emitting device, preferably a light emitting diode (LED), mounted on the surface of the housing and exposed thereon so that a user may see when the wireless earphones or headphones are in an operable mode or, perhaps, in a charging mode, and a micro USB or mini USB male charging connector, or plug. The electronic circuitry on the printed circuit board within the control unit, or microphone housing, is connected to a pair of speakers housed within the ear pieces forming part of the earphones or headphones. The battery or batteries may be installed in the two ear pieces, or may be situated within the control unit, or microphone housing.

The control unit, or microphone housing, preferably has a pivotable, and even more preferably, foldable, male connector plug preferably in the form of a micro or mini USB connector. The plug may be pivoted outwardly, away from the control unit or microphone housing, and unfolded to conform to the shape of a standard micro or mini USB plug. The advantage of such a design is that there are no extra cables required for charging the internal battery of the earphones or headphones. Rather, the male connector of the control unit or microphone housing, which is exposed when pivoted away from the control unit or microphone housing and useable when unfolded, may be plugged directly into a laptop computer or other source of power having a compatible micro or mini USB female connector, without the need for a cable extending between the two devices.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a perspective view of earphones, or ear buds, formed as an assembly with a control unit or microphone housing having a pivotable USB-like male connector, formed in accordance with the present invention.

FIG. 2 is an exploded perspective view of the control unit for the earphone assembly shown in FIG. 1 and formed in accordance with the present invention.

FIG. 3 is an exploded perspective view of a pivotable and foldable USB-like male connector mounted on the control unit or microphone housing of the earphone assembly and formed in accordance with the present invention.

FIG. 4 is an exploded view of the pivotable and foldable USB-like male connector mounted on the control unit or microphone housing of the earphone assembly of the present invention.

FIG. 5 is a perspective view of the control unit or microphone housing having a pivotable and foldable USB charging male connector for an earphone or headphone assembly and formed in accordance with the present invention.

FIG. 6 is a perspective view of the pivotable and foldable USB-like male connector formed in accordance with the present invention and illustrated in an unfolded state.

FIG. 7 is a perspective view of the control unit or microphone housing for an earphone or headphone assembly and formed in accordance with the present invention, and shown with the USB-like male connector in a folded and retracted state on the housing thereof.

FIG. 8 is a perspective view of the control unit or microphone housing of an earphone or headphone assembly and formed in accordance with the present invention, and illustrating the USB-like male connector thereof in a pivoted state.

FIG. 9 is a perspective view of the control unit or microphone housing of an earphone or headphone assembly and formed in accordance with the present invention, and illustrating the USB-like male connector thereof in a pivoted state.

FIG. 10 is a perspective view of the control unit or microphone housing of an earphone or headphone assembly and formed in accordance with the present invention, and illustrating the USB-like male connector thereof in a pivoted state, and further illustrating the USB-like connector in an unfolded state.

FIG. 11 is a perspective view of the control unit or microphone housing of an earphone or headphone assembly and formed in accordance with the present invention, and illustrating the USB-like male connector thereof in a pivoted state, and further illustrating the USB-like connector in an unfolded state.

FIG. 12 is a perspective view of the electrical contacts and associated wiring and connections forming part of the USB-like male connector mounted on the control unit or microphone housing of an earphone or headphone assembly, formed in accordance with the present invention.

FIG. 13 is a perspective view of the electrical contacts and associated wiring and connections for the part of the USB-like male connector mounted on the control unit or microphone housing of an earphone or headphone assembly, formed in accordance with the present invention.

FIG. 14 is an exploded perspective view of a USB-like male connector of the control unit or microphone housing for an earphone or headphone assembly, formed in accordance with the present invention.

### DETAILED DESCRIPTION OF THE PREFERRED EMBODIMENTS

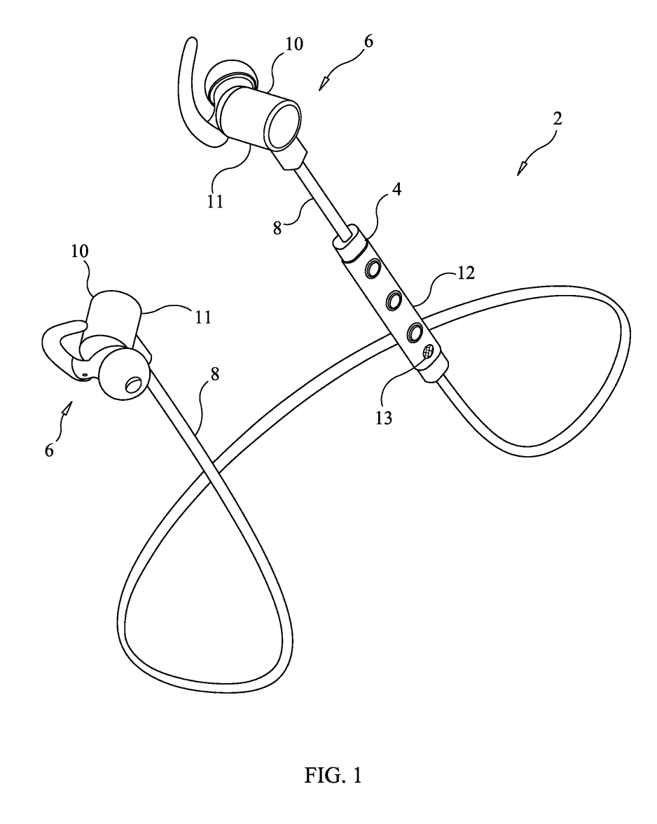

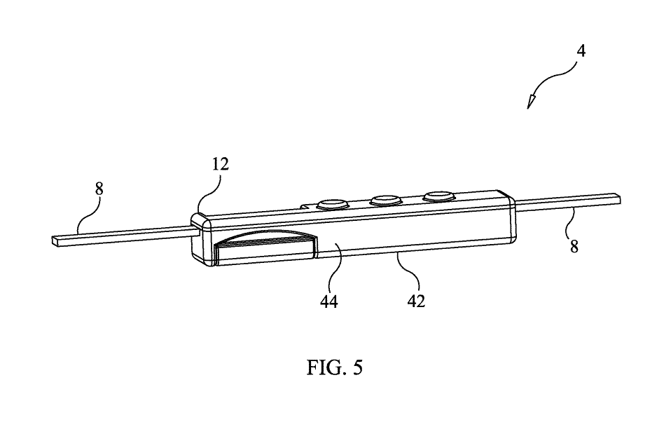

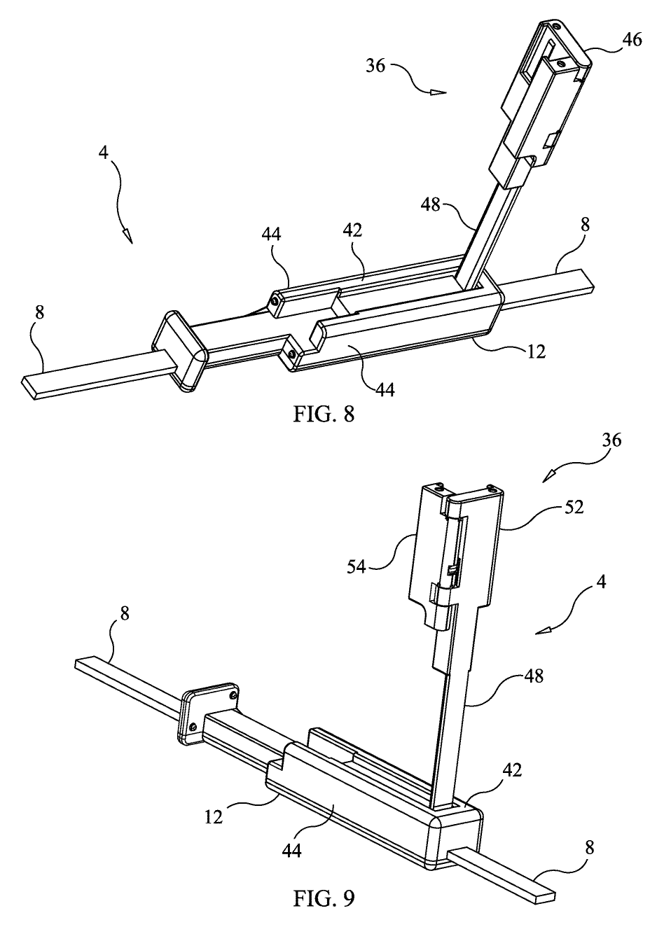

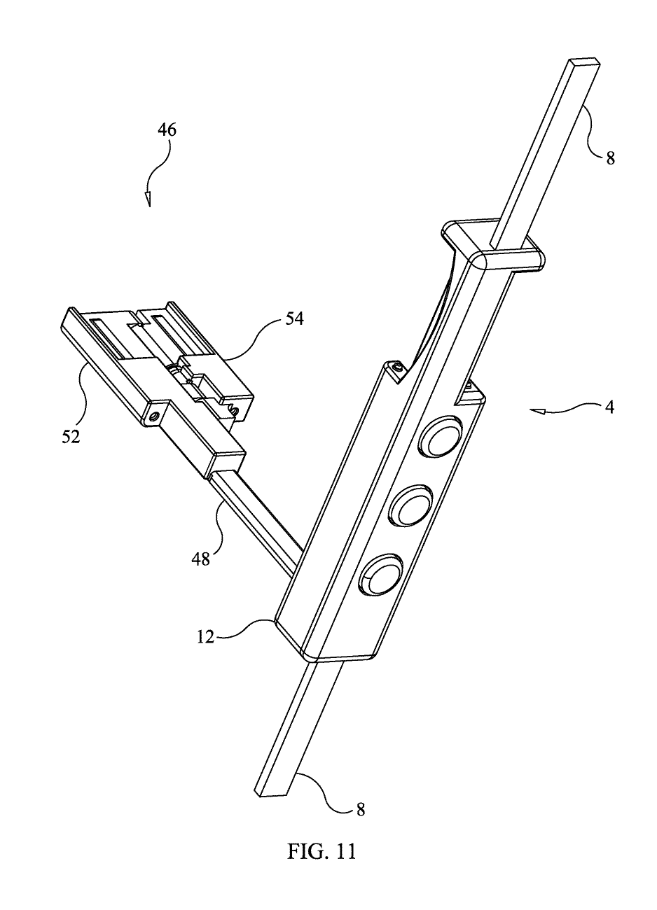

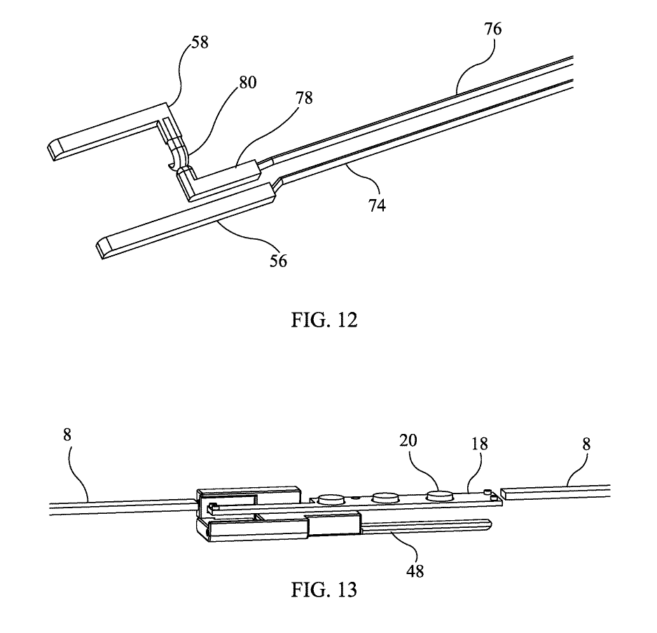

Referring initially to FIGS. 1-14 of the drawings, it will be seen that a wireless earphone or headphone assembly 2 constructed in accordance with the present invention include a control unit or microphone case 4, a pair of ear pieces 6 to cover (in the case of headphones) or insert partially into (in the case of earphones) a user's left and right ears, and electrical cables 8 extending between the control unit 4 and the ear pieces 6. Each ear piece 6 has a housing 10 in which a speaker or transducer is mounted, and may include an internal battery within the housing 10 thereof The speakers or transducers, and the batteries, are connected via the electrical cables 8 to the control unit 4. Alternatively, the control unit 4 may include one or more batteries mounted within the housing 12 thereof to power the speakers of the ear pieces 6 of the earphones or headphones. The control unit 4 or microphone case will now be described. In the following description, only the control unit 4 is referred to. However, it should be understood that the primary difference between the control unit 4 and the aforementioned microphone case is that a microphone 13 may be included in the control unit housing 12.

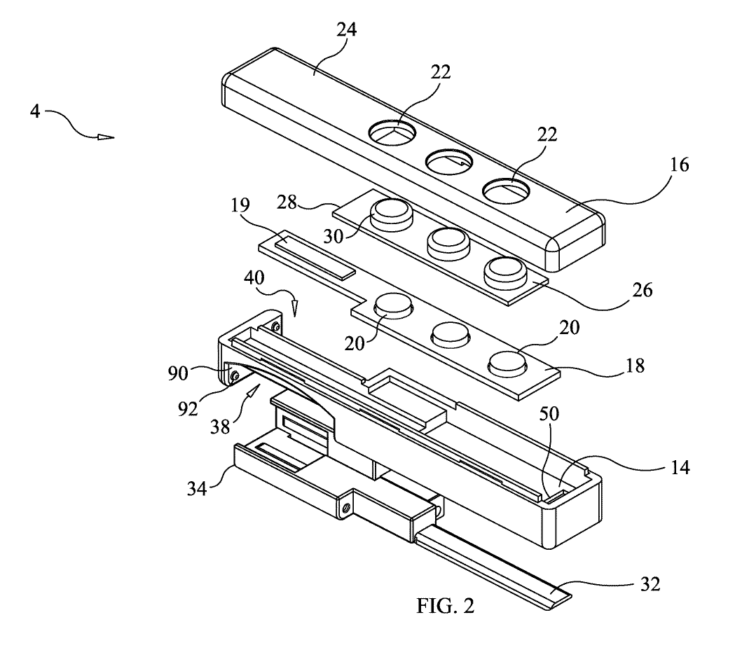

A control unit 4, formed in accordance with the present invention, for use with earphones or headphones, basically includes a housing 12 formed in preferably two sections, as shown in FIG. 2 of the drawings, that is, a bottom section 14 and a top section 16 which is mateable to the bottom section 14. Together, the bottom section 14 and the top section 16 of the control unit housing 12 define an internal cavity in which is received a printed circuit board 18. Control switches 20 (for example, on/off, volume up and volume down) are mounted on the printed circuit board 18, with any additional electronic components, for operation of the earphones or headphones. In the example of the control unit 4 shown in FIG. 2 of the drawings, there are three control switches 20 which are illustrated. However, it should be understood that there may be more than three switches 20, and different types of switches, forming part of the control unit 4 of the present invention. The switches 20 shown in FIG. 1 and mounted on the printed circuit board 18 are preferably push button switches.

In the top section 16 of the control unit housing 4, there are three holes 22 formed through the thickness of the top wall 24 thereof. The three holes 22 are aligned with the three push button switches 20 mounted on the printed circuit board 18. Preferably, a rubber button tree 26, or gasket, in the form of a planar member 28 having three flexible, rubber button covers 30 formed integrally with and protruding outwardly from the rubber planar member 28, is mounted over the printed circuit board 18 and, in particular, over the three push button switches 20 thereon so that each rubber button cover 30 covers a respective push button switch 20. The covers 30 of the rubber button tree 26 are also aligned with the openings 22 formed through the thickness of the top section 16 of the control unit housing 12 so that the rubber covers 30 extend through the openings 22. The user of the earphones or headphones may easily press down on the rubber button covers 30 of each push button switch 20 to activate the switches and to control the function of the earphone or headphone assembly 2.

The electrical cables 8 which run between the ear pieces 6 of the earphones or headphones and the control unit 4 are electrically connected to the printed circuit board 18. Also, as mentioned previously, the control unit 4 may include a microphone that is mounted on the printed circuit board 18, or elsewhere on the control unit 4. Because the preferred form of the control unit 4 is Bluetooth-enabled so that it may wirelessly communicate with a compatible mobile or remote device (e.g., laptop computer, smart phone, iPad® device, iPod® device and the like), the printed circuit board 18 also includes, in this preferred form, transmit and receive circuitry to allow the control unit 4 to wirelessly communicate with an external device. A light emitting diode (LED), or other indicator (not shown), may be mounted on a wall of the control unit housing 12 to indicate when the battery or batteries of the earphones or headphones require charging, or the charge state of the batteries.

One of the primary features of the control unit 4 of the present invention is that it includes a male USB connector 32 which rotates or pivots on the housing 12 of the control unit 4 from a stored position to an outwardly extended position so that it may be directly inserted into a compatible female USB connector on a laptop computer or other device for charging the batteries either situated within the control unit 4 or the housings of the ear pieces 6 of the earphones or headphones. The structure of the control unit 4 relating to this feature is shown in FIGS. 2-14 of the drawings.

More specifically, the USB male connector 32, or plug, is formed as a member that can pivot away from the housing 12 of the control unit 4, the free end 34 of which is receivable by a compatible USB female connector mounted on a laptop computer or other device which provides +5 VDC and ground for charging the internal batteries of the earphone or headphone assembly 2 of which the control unit 4 forms part. Pins (preferably, Pin 1 and Pin 4) are exposed when the USB plug 32 is pivotally extended so that they may make electrical contact with aligned contacts of a compatible USB female receptacle of a charging device or a power source. Preferably, the USB plug 32 is pivotably mounted on the bottom section 14 of the control unit housing 12.

As can be seen from the drawings, the male USB connector 32, or plug, be it a micro, mini or standard USB plug, is not only pivotably connected to the control unit housing 12, but also may be folded for storage against the control unit housing 12 and unfolded for use to connect to a compatible female USB connector on a laptop computer or other device for charging the internal batteries of the headphone or earphone assembly 2.

More specifically, and as can be seen from FIGS. 2, 5 and 7-11 of the drawings, a USB connector assembly 36 is mounted on the bottom section 14 of the control unit 4 (or microphone case) and situated in recesses 38, 40 formed in the bottom wall 42 and at least one lateral side wall 44 of the bottom section 14. The USB connector assembly 36 includes a foldable connector portion 46, and a cable 48 containing electrical wires and preferably in the form of a ribbon cable or flat cable, extending outwardly from the foldable connector portion 46 of the assembly 36. The cable 48, and in particular the electrical wires therein, pass through an opening 50 formed in the recessed portion of the bottom wall 42 of the bottom section 14 of the control unit housing 12 and are electrically connected to either the printed circuit board 18 or directly to electrical wires that pass through the cables 8 connecting the ear pieces 6 with the printed circuit board 18 and which are used for charging the batteries located either within the housings 10 of the ear pieces 6 of the headphones or earphones, or within the control unit 4 itself The cable 48, forming part of the pivotable and foldable USB connector assembly 36, retains the foldable connector portion 46 of the assembly 36 to the control unit housing 12 and allows the connector assembly 36 to pivot from a position against the bottom wall 42 of the bottom section 14 of the control unit 4 outwardly, to preferably about a 90 degree angle from the bottom wall 42 of the bottom section 14 of the control unit 4. In this extended position, the foldable connector portion 46 of the USB connector assembly 36, being a male plug, may be easily received by a compatible female USB connector on a laptop computer or other charging device, without the housing 12 of the control unit 4 interfering with the insertion of the male plug 46 of the USB connector assembly 36 into the compatible female USB connector of a charging device.

Alternatively, instead of just a cable 48 providing flexibility for the USB connector assembly 36 to be pivoted away from the control unit housing 12 and for retaining the USB connector assembly 36 to the control unit 4, an elongated member having electrical conduits situated thereon may be used and having one axial end thereof pivotally mounted to the bottom section 14 of the control unit housing 12, with the foldable connector portion 46 of the USB connector assembly 36 being mounted on the opposite axial end thereof. The elongated member may be formed from the same material of which the control unit housing 12 is formed, and may provide further rigidity to the USB connector assembly 36 as it pivots toward and away from the control unit housing 12.

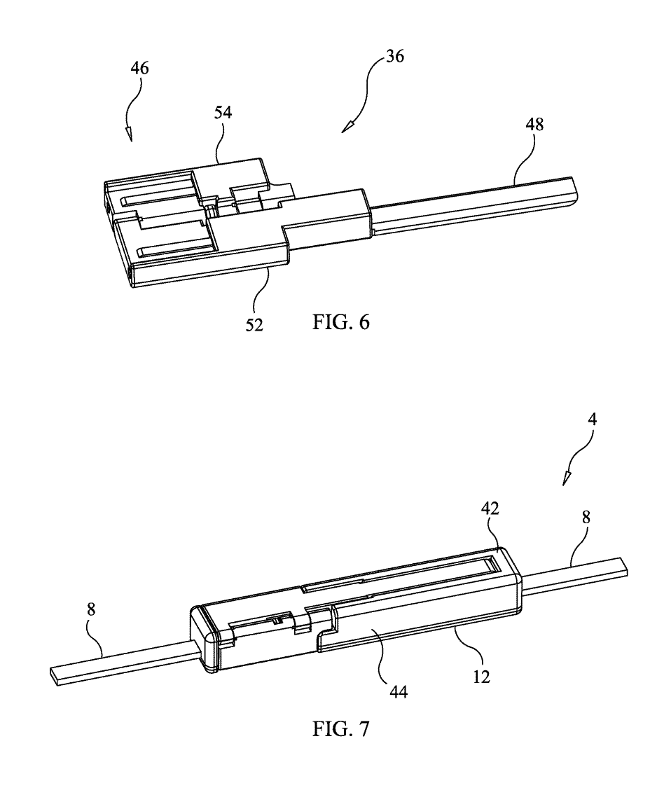

As also can be seen from FIGS. 6, 10 and 14 of the drawings, the main connector portion 46 of the USB connector assembly 36, that is, the USB-like plug connector itself, preferably comes in two sections 52, 54 which are pivotally or hingedly mounted together so that they may be folded relative to one another to form about a 90 degree angle therebetween, and pivotally unfolded so that the two sections 52, 54 reside coplanarly (that is, that the two sections 52, 54 are about 180 degrees relative to each other). When unfolded, the two pivotally connected sections 52, 54 resemble a typical USB male connector, or plug, that is insertable into a compatible USB female connector mounted on a laptop computer or other device for charging the batteries of the headphone or earphone assembly 2.

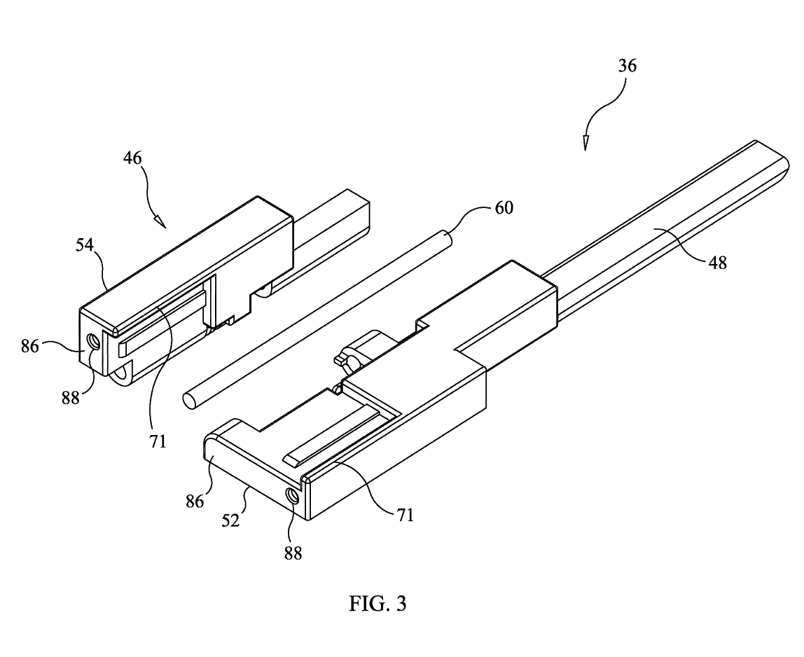

In order to charge the batteries of the headphone or earphone assembly 2, two spaced apart contacts or pins 56, 58, preferably situated as Pin 1 and Pin 4 of a typical USB connector, are provided on the foldable USB connector portion 46 of the assembly 36. One pin 56 (Pin 1) is situated in or on the first section 52, and the other pin 58 (Pin 4) is situated in or on the second section 54 which pivots on the first section 52. In a typical USB connector, +5 VDC is provided on Pin 1, and ground is provided on Pin 4. Accordingly, when the two sections 52, 54 of the foldable connector portion 46 of the USB connector assembly 36 are unfolded to be coplanar, Pin 1 and Pin 4 of the two sections 52, 54 are aligned to mate with and be electrically connectible to Contacts 1 and 4 of a compatible USB female connector when the foldable male plug 46 is inserted into the compatible female connector, which will allow voltage and ground connections to be made through the male connector portion 46 to either the printed circuit board 18 within the control unit 4 or directly to the ear pieces 6 of the headphones or earphones in order to charge the batteries therein. The structure of the pivotable and foldable USB connector assembly 36 will now be described in greater detail, and reference should be had to FIGS. 3, 4 and 12-14 of the drawings.

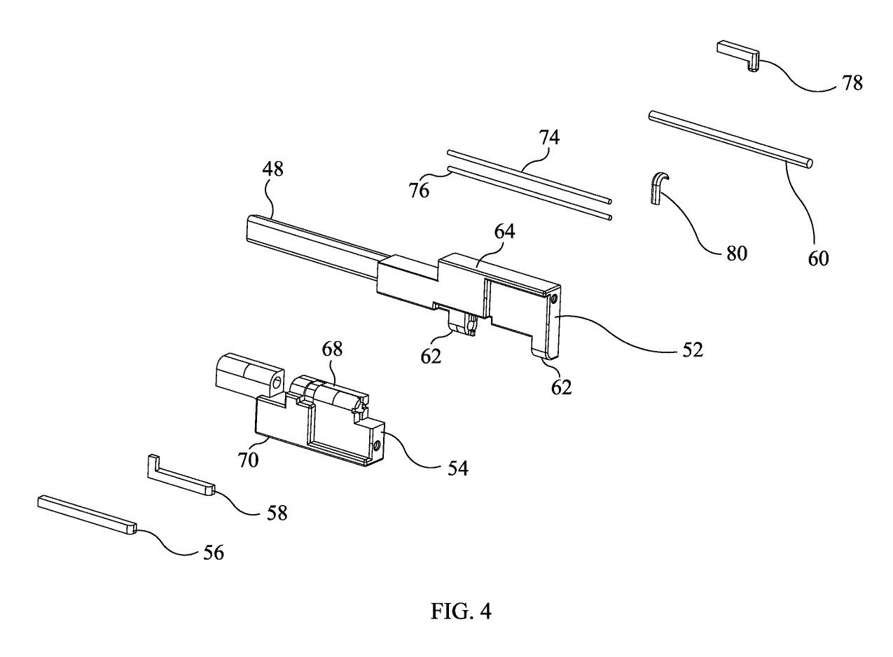

As can be seen from FIGS. 3 and 4 of the drawings, the USB connector assembly 36, as mentioned previously, includes a connector portion 46 and an interconnecting cable 48, which cable 48 connects the foldable connector portion 46 to the control unit housing 12 and allows the USB connector assembly 36 to pivot thereon. As also mentioned previously, the connector portion 46 of the assembly 36 is foldable so that it may be placed against the bottom wall 42 and one lateral side wall 44 of the bottom section 14 of the control unit housing 12, and unfoldable so that it may be used for charging the batteries of the headphone or earphone assembly 2.

The foldable connector portion 46 of the USB connector assembly 36 includes a first section 52, and a second section 54 which is pivotally mounted on the first section 52. The first section 52 is the section to which the cable 48, or another elongated member having electrically conductive conduits, is connected, and the second section 54 pivots on the first section 52. The first and second sections 52, 54 are connected using a pivot or hinge pin 60. Two hinge legs 62 extend outwardly from the main body portion 64 of the first section 52, which legs 62 are spaced apart from each other and which legs 62 further include a bore 66 formed therein. The second section 54, which is pivotable on the first section 52, also includes a protruding hinge portion 68 that extends from the main body portion 70 thereof, and this protruding hinge portion 68 is dimensioned to be received between the two spaced apart hinge legs 62 of the first section 52. The protruding hinge portion 68 of the second section 54 of the foldable connector portion 46 also includes a bore 72 formed axially therethrough. When the second section 54 is fitted onto the first section 52, the bore 72 formed through the protruding hinge portion 68 of the second section 54 is in alignment with the bores 66 formed in the hinge legs 62 of the first section 52, and the hinge pin 60 is received axially through the aligned bores 66, 72 to hold the second section 54 on the first section 52 but to allow the second section 54 to pivot thereon between at least about a 90 degree angle relative to the first section 52 and about a 180 degree angle relative to the first section 52.

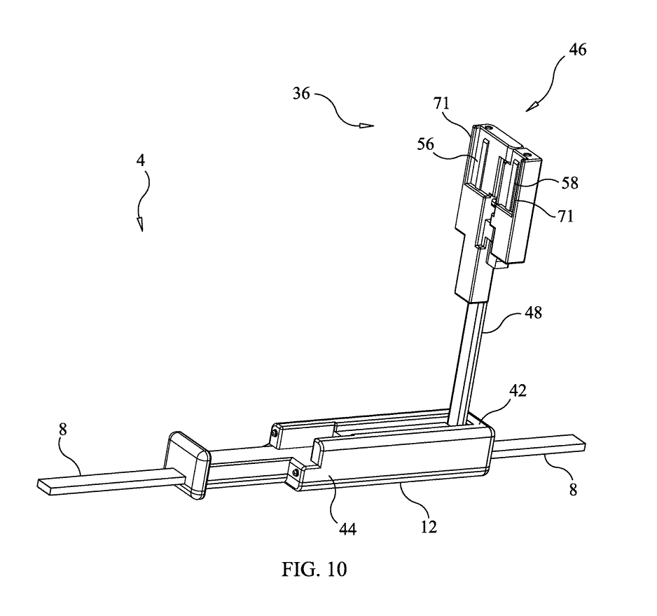

A conductor or contact 56 (Pin 1) is mounted on the main body portion 64 of the first section 52 and is exposed thereon so as to be in electrical communication with Contact 1 of a compatible female USB connector when the male connector portion 46, in its unfolded state, of the USB connector assembly 36 is received by the female connector of the charging device. The main body portion 70 of the second section 54, which pivots on the first section 52, includes another exposed pin or contact 58, in this case, Pin 4, mounted on a surface thereof, and which will electrically connect with Contact 4 on a female USB connector of the charging device when the male connector portion 46 of the USB connector assembly 36, in its unfolded state, is received thereby. As shown in FIGS. 3 and 10 of the drawings, the opposed outer side walls of the connector sections 52, 54 may extend outwardly beyond the plane of the surfaces on which the contacts 56, 58 reside to form orientation shoulders 71. The orientation shoulders 71 prevent the unfolded USB-type connector portion 46 from being inadvertently inserted into a compatible USB connector of a power source in a 180 degree incorrect disposition, as the shoulders 71 will only allow the connector portion 46 to enter the USB charging port in a single orientation.

As can be seen from FIGS. 4, 12 and 13 of the drawings, a first wire 74, which passes through the cable 48 of the USB connector assembly 36, is connected directly to Pin 1 (contact 56) on the first section 52 of the foldable connector portion 46 of the USB connector assembly 36. This wire 74 carries the +5 VDC from Pin 1 to the printed circuit board 18 or directly to the batteries of the headphone or earphone assembly 2 when the unfolded connector portion 46 is received by a compatible female connector on the charging device. A second wire 76 of the cable 48 is connected to a right angle, L-shaped contact 78 mounted on the first section 52 of the foldable connector portion 46 of the USB connector assembly 36. The axial end of the long leg of the L-shaped contact 78 is connected to this second wire 76 that passes through the cable 48 of the USB connector assembly 36, and the free end of the shorter second leg of the contact 78 engages the resilient, curved end of a spring contact 80 that is mounted on the second section 54 of the foldable connector portion 46 of the USB connector assembly 36 and which pivots on the first section 52. The opposite axial end of the spring contact 80 engages the shorter leg of an L-shaped contact 58 (Pin 4) that is also mounted and exposed on the second section 54 of the foldable connector portion 46 of the USB connector assembly 36. Thus, when the second section 54 is pivoted away from the first section 52 so that both sections 52, 54 are coplanar to each other, the spring contact 80 will ensure that the USB Pin 4 contact 58 on the second section 54 will remain in electrical communication with the second wire 76 of the cable 48 of the USB connector assembly 36 when in this unfolded state. As mentioned previously, Pin 4 would be at ground potential when the unfolded connector plug portion 46 is received by a compatible USB female connector on a charging device, such as a laptop computer, and this ground is carried through the spring contact 80, L-shaped contact 78 and second wire 76 of the cable portion 48 of the USB connector assembly 36 in order to provide a ground to the printed circuit board 18 or to the ear pieces 6 of the headphones or earphones through the electrical cable 8 which interconnects the headphones and earphones with the control unit 4.

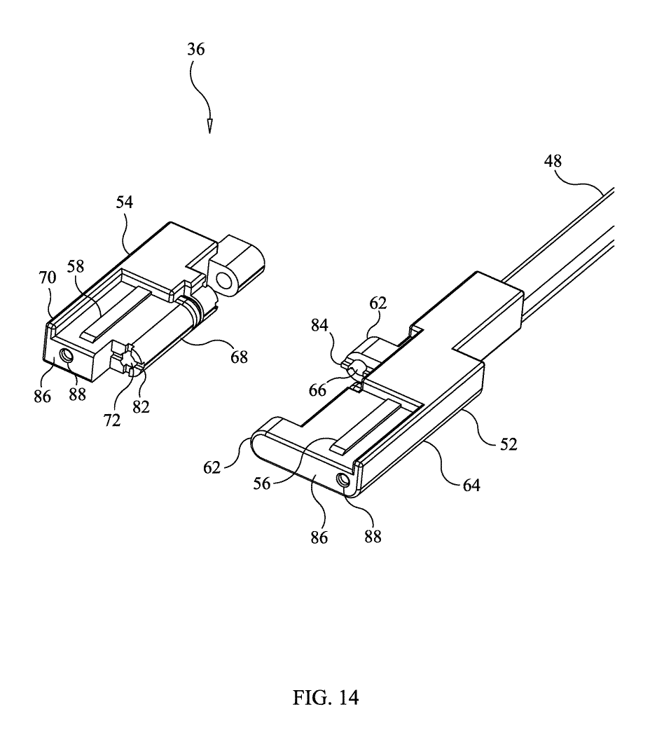

As can be seen from FIG. 14 of the drawings, the opposite axial surfaces of the protruding hinge portion 68 of the second section 54 of the foldable connector portion 46 of the USB connector assembly 36 preferably include slots or recesses 82 formed diametrically therein. On facing surfaces of the hinge legs 62 of the first section 52, there are formed diametrically situated protrusions 84 or prongs projecting outwardly therefrom. These protrusions 84 or prongs are selectively receivable within the recesses 82 or slots of the second section 54 when the two sections 52, 54 are mated together. The protrusions 84 of the first section 52 and the recesses 82 of the second section 54 are provided to selectively maintain the two sections 52, 54 in a folded state (where the two sections 52, 54 are at an angle of about 90 degrees relative to one another) and in an unfolded state (where the two sections 52, 54 are at an angle of about 180 degrees relative to each other). Of course, it should be realized that the location of the protrusions 84 on the first section 52 and the recesses 82 on the second section 54 may be interchanged; that is, the protrusions 84 may be fanned on the axial surfaces of the hinge portion 68 of the second section 54, and the recesses 82 may be formed in the axial surfaces of the hinge legs 62 of the first section 52.

As stated previously, when in its folded state, the connector portion 46 of the USB plug connector assembly 36 has its two sections 52, 54 at right angles to one another. The first section 52 fits into the recess 38 formed in the bottom wall 42 of the bottom section 14 of the control unit housing 12 so that it is preferably flush with the surface of the bottom wall 42 when received in the recess 38 thereof, and the folded second section 54 is received in a recess 40 formed in a lateral side wall 44 of the bottom section 14 and so that the second section 54 lies flush with the surface of the lateral side wall 44 when received in the recess 40 thereof The cable 48, or elongated member, carrying electrical wires 74, 76 of the USB connector assembly 36 is also received in the recess 38 formed in the bottom wall 42 of the control unit housing 12 so that it is flush with the surface of the bottom wall 42. This provides the control unit housing 12 or microphone case with an aesthetically pleasing appearance, generally as a rectangular parallelepiped, as shown in FIGS. 1, 5 and 7 of the drawings.

In order to maintain the USB plug connector assembly 36 against the surfaces of the control unit housing 12 and within the recesses 38, 40 formed therein, one end face 86, or opposite end faces, of each of the first and second sections 52, 54 of the foldable connector portion 46 may have formed therein a slightly projecting bump 88, and exposed lateral inner walls 90 of the bottom section 14 of the control unit housing 12 which define the recesses 38, 40 for receiving the first and second sections 52, 54 of the foldable connector portion 46 may be formed with dimples 92 that are situated to be in alignment with the bumps 88 formed in the first and second sections 52, 54 of the foldable connector portion 46 to hold the USB plug connector assembly 36 in place within the recesses 38, 40 on the bottom section 14 of the control unit housing 12 until pressure is exerted by the user of the headphone or earphone assembly 2 to overcome the resistance provided by the mating bumps 88 and dimples 92 in order to pivot the USB connector assembly 36 away from the bottom section 14 of the control unit housing 12. Of course, it should be understood that the locations of the dimples 92 and bumps 88 may be interchanged.

Other latching mechanisms may be used to hold the USB connector assembly 36 in place on the housing 12 of the control unit 4 or microphone case until released by the user. Also, a spring mechanism may be included on the control unit 4 to facilitate the release and/or pivoting of the USB connector assembly 36 from the control unit housing 12. For example, a leaf spring or compression spring (not shown) may be situated within the recess 38 formed in the bottom wall 42 of the bottom section 14 of the housing 12 and exerting a force on the foldable connector portion 46 of the USB connector assembly 36 to help force the connector portion 46 away from the control unit housing 12 when the user applies sufficient force on the USB connector assembly 36 to disengage the bumps 88 from the dimples 92.

The present invention, with its USB-like male connector 34, or plug, that is both pivotable and unfoldable to standard USB dimensions, provides a compact and readily accessible implement for charging the batteries of the headphones or earphones without the need for a separate USB charging cable. The USB plug 34 fits nicely into recesses 38, 40 formed in the control unit 4, yet may be easily extended, and unfolded, for charging purposes, and when not in use, may be folded and pivoted back onto the control unit housing 12 or microphone case in an aesthetically pleasing manner. Thus, the user of the headphones or earphones need not carry around a separate charging cable, which can easily be forgotten or mislaid.

Although only Pins 1 and 4 are shown in the drawings and described previously as being mounted on the first and second sections 52, 54 of the pivotable and foldable USB connector assembly 36, it should be understood that pins or contacts different from Pins 1 and 4 shown and described, or in addition to Pins 1 and 4, may be included and mounted on the foldable connector portion 46 of the USB connector assembly 36. For example, the hinged first and second sections 52, 54 may, in addition to or in lieu of Pins 1 and 4, include data pins (i.e., Pins 2 and 3) that carry data thereon between a host device and the electrical device (e.g., the control unit 4 of the headphone or earphone assembly 2, or some other device) on which the foldable and pivotable USB male connector 32 is mounted, in order to eliminate the need for the user to carry a separate cable that interconnects the two devices, for either charging purposes or to transmit and/or receive data.

Furthermore, although the male USB connector 32 is described, in the example given, for charging the batteries of an earphone or headphone assembly 2 by directly plugging the connector into a USB female port on a charging device, such as a laptop computer, it is envisioned to be within the scope of the present invention to use a male USB connector on devices other than the described earphone or headphone assembly 2 and which folds and/or pivots away from the housing of the electronic device. Such devices may include, but are not limited to, smartphones, thumbdrives and flash memory storage devices, external hard drive memories, tablets, cell phones, MP3 and personal audio devices, personal gaming devices, personal video devices, e-readers, personal health electronic devices, video cameras, digital cameras, Bluetooth™ speakers, personal safety devices, rechargeable flashlights, children's games, power bank chargers, portable power devices, connected card devices and the like.

If such a device requires the male USB connector 32 to extend farther away from the body of the device, the cable portion 48 of the USB connector assembly 36 may be formed with whatever length is needed or desired to reach a host device for charging or data transfer.

The wireless earphone or headphone assembly will now be further described. More specifically, a wireless earphone or headphone assembly 2 formed in accordance with the present invention and used for communicating wirelessly with an external audio source, the external audio source generating an output signal, preferably includes a control unit 4, the control unit 4 having a housing 12, the housing 12 defining an internal cavity. The assembly 2 also preferably includes electronic circuitry 18 for receiving the output signal generated by the external audio source and generating a speaker signal in response thereto, at least a portion of the electronic circuitry 18 being situated within the internal cavity of the control unit 4 or mounted on the housing 12 of the control unit 4. The assembly 2 further preferably includes at least one ear piece 6, the at least one ear piece 6 including a housing 10 having an exterior wall, the ear piece housing 10 defining an internal cavity, and at least one speaker 11. The at least one speaker 11 is situated at least partially within the internal cavity of the ear piece housing 10 and is electrically coupled to the electronic circuitry 18. The speaker 11 is responsive to the speaker signal of the electronic circuitry 18 and generates an audible sound in response thereto.

The assembly 2 also further includes at least one battery 19. The at least one battery 19 is situated at least partially within at least one of the internal cavity of the ear piece housing 10 and the internal cavity of the control unit housing 12. The at least one battery 19 is in electrical communication with the electronic circuitry 18.

The assembly 2 further preferably includes at least one elongated power connector plug 36. The at least one power connector plug 36 is releasably mounted on the housing 12 of the control unit 4 and is extendable therefrom. The at least one power connector plug 36 has a first axial end coupled to the control unit 4, and a second axial end situated opposite from the first axial end.

Furthermore, the assembly 2 preferably includes a USB-type male connector 46. The USB-type male connector 46 is situated at the second axial end of the at least one power connector plug 36. The at least one power connector plug 36 is positionable relative to the housing 12 of the control unit 4 in a first position in which the at least one power connector plug 36 is situated in close proximity to the housing 12 of the control unit 4, and in at least a second position in which the at least one power connector plug 36 extends outwardly from the housing 12 of the control unit 4. When in the second position, the USB-type male connector 46 situated at the second axial end of the at least one power connector plug 36 is matable with a compatible USB-type female connector of an external power source in order to charge the at least one battery 19 of the wireless earphone or headphone assembly 2.

In a preferred form of the present invention, the USB-type male connector 46 of the wireless earphone or headphone assembly 2 situated at the second axial end of the at least one power connector plug 36 includes a first section 52 and a second section 54, the second section 54 being pivotally joined to the first section 52 and pivotable relative to the first section 52 between a first position and at least a second position. When the second section 54 is in the first position, the second section 54 resides substantially coplanarly with the first section 52 such that the USB-type male connector 46 is in an unfolded state. When the second section 54 is in the second position, the second section 54 resides substantially non-coplanarly to the first section 52 such that the USB-type male connector 46 is in an at least partially folded state.

Preferably, the at least one power connector plug 36 includes a pivot pin 60. Each of the first section 52 and the second section 54 of the USB-type male connector 46 situated at the second axial end of the at least one power connector plug 36 is connected to the pivot pin 60 such that the second section 54 is pivotable with respect to the first section 52 about the pivot pin 60.

Even more preferably, the first section 52 of the USB-type male connector 46 of the at least one power connector plug 36 includes a first electrical contact 56 mounted thereon, and the second section 54 of the USB-type male connector 46 of the at least one power connector plug 36 includes a second electrical contact 58 mounted thereon. Furthermore, the first section 52 of the USB-type male connector 46 of the at least one power connector plug 36 preferably includes a third electrical contact 78 mounted thereon, and at least one of the first section 52 and the second section 54 of the USB-type male connector 46 of the at least one power connector plug 36 includes an electrical spring contact 80. The spring contact 80 electrically engages the second electrical contact 58 of the second section 54 and the third electrical contact 78 of the first section 52 to provide an electrical circuit therebetween when the second section 54 is at least in the first position and the USB-type male connector 46 is at least in the unfolded state.

The housing 12 of the control unit 4 of the wireless earphone or headphone assembly 2 preferably includes a first wall 42 and a second wall 44 situated adjacent to the first wall 42. In this embodiment of the invention, the first section 52 and the second section 54 of the USB-male type connector 46 situated at the first axial end of the at least one power connector plug 36 reside substantially coplanarly respectively with the first wall 42 and the second wall 44 of the housing 12 of the control unit 4 when the at least one power connector plug 36 is in the first position.

Even more preferably, each of the first wall 42 and the second wall 44 of the housing 12 of the control unit 4 has an outer surface, and each of the first section 52 and the second section 54 of the USB-type male connector 46 has an outer surface. When the at least one power connector plug 36 is in the first position, and the second section 54 of the USB-type male connector 46 is in the second position such that the USB-type male connector 46 is in the at least partially folded state, the outer surface of the first section 52 resides substantially flush with the outer surface of the first wall 42 of the housing 12 of the control unit 4, and the outer surface of the second section 54 resides substantially flush with the outer surface of the second wall 44 of the housing 12 of the control unit 4.

In an even more preferred form of the wireless earphone or headphone assembly 2 of the present invention, the outer surface of the first wall 42 of the housing 12 of the control unit 4 is substantially perpendicular to the outer surface of the second wall 44 of the housing 12 of the control unit 4. When the second section 54 of the USB-type male connector 46 is in the second position, the second section 54 resides substantially perpendicularly to the first section 52 of the USB-type male connector 46.

In another form of the wireless earphone or headphone assembly 2 of the present invention, the outer surface of the first wall 42 of the housing 12 of the control unit 4 has a first recess 38 formed therein, and the outer surface of the second wall 44 of the housing 12 of the control unit 4 has a second recess 40 formed therein. The first section 52 of the USB-type male connector 46 and the second section 54 of the USB-type male connector 46 of the at least one power connector plug 36 are respectively received by the first recess 38 formed in the outer surface of the first wall 42 of the housing 12 of the control unit 4 and the second recess 40 formed in the outer surface of second wall 44 of the housing 12 of the control unit 4 when the second section 54 is in the second position such that the USB-type male connector 46 is in the at least partially folded state and when the at least one power connector plug 36 is in the first position.

In yet another form, the wireless earphone or headphone assembly 2 of the present invention may include structure to releasably hold the at least one power connector plug 36 to the housing 12 of the control unit 4. More specifically, the first wall 42 of the housing 12 of the control unit 4 preferably includes one of a detent 92 and a recess 88, the second wall 44 of the housing 12 of the control unit 4 preferably includes one of a detent 92 and a recess 88, the first section 52 of the USB-type male connector 46 of the at least one power connector plug 36 preferably includes one of a recess 88 and a detent 92, and the second section 54 of the USB-type male connector 46 of the at least one power connector plug 36 preferably includes one of a recess 88 and a detent 92. When the at least one power connector plug 36 is in the first position, and the second section 54 of the USB-type male connector 46 is in the second position such that the USB-type male connector 46 is in the at least partially folded state, the one of the recess 88 and the detent 92 of the first section 52 engages the one of the detent 92 and the recess 88 of the first wall 42 of the housing 12 of the control unit 4, and the one of the recess 88 and the detent 92 of the second section 54 engages the one of the detent 92 and the recess 88 of the second wall 44 of the housing 12 of the control unit 4 to thereby releasably secure the first section 52 of the USB-type male connector 46 to the first wall 42 of the housing 12 of the control unit 4 and the second section 54 of the USB-type male connector 46 to the second wall 44 of the housing 12 of the control unit 4.

Preferably, each of the first section 52 and the second section 54 of the USB-type male connector 46 of the at least one power connector plug 36 includes an orientation shoulder 71 formed thereon. The orientation shoulders 71 allow the USB-type male connector 46, when in the unfolded state, to be mateable with (e.g., insertable into) the compatible USB-type female connector of the external power source only when the unfolded USB-type male connector 46 is in a particular orientation relative to the compatible USB-type female connector of the external power source.

In another form of the present invention, the first section 52 and the second section 54 of the USB-type male connector 46 of the wireless earphone or headphone assembly 2 respectively include a first portion 62 and a second portion 68, the first portion 62 of the first section 52 engaging the second portion 68 of the second section 54. Furthermore, each of the engaging first and second portions 62, 68 of the first and second sections 52, 54 of the USB-type male connector 46 has one of at least one protrusion 84 and at least one recess 82. The at least one protrusion 84 is at least partially receivable by the at least one recess 82 to selectively maintain the second section 54 relative to the first section 52 in at least one of the first position and the second position such that the USB-type male connector 46 is selectively maintained in at least one of the unfolded state and the at least partially folded state.

The at least one power connector plug 36 may include electrical wires 48 joining the first axial end of the at least one power connector plug 36 to the electronic circuitry 18 situated within the internal cavity of the housing 12 of the control unit 4. Also, the housing 12 of the control unit 4 further may include a first section 14 and a second section 16 joined to the first section 14, the first section 14 and the second section 16 together defining the internal cavity of the housing 12 of the control unit 4. Also, a microphone 13 may be mounted on the housing 12 of the control unit 4.

The present invention is also directed to a portable, handheld, electronic device 4. The device 4 preferably includes a housing 12, the housing 12 defining an internal cavity, a rechargeable battery 19 situated within the internal cavity of the housing 12, at least one power connector structure 36, the at least one power connector structure 36 being mounted on the housing 12 of the portable, handheld, electronic device 4 and being extendable therefrom, the at least one power connector structure 36 having a first axial end joined to the housing 12 or extending into the internal cavity defined by the housing 12 of the portable, handheld, electronic device 4, and a second axial end situated opposite from the first axial end, and a USB-type connector 46, the USB-type connector 46 being situated at the second axial end of the at least one power connector structure 36.

The at least one power connector structure 36 is positionable relative to the housing 12 of the portable, handheld, electronic device 4 in a first position in which the at least one power connector structure 36 is situated in close proximity to the housing 12 of the portable, handheld, electronic device 4, and in at least a second position in which the at least one power connector structure 36 extends outwardly from the housing 12 of the portable, handheld, electronic device 4. When in the second position, the USB-type connector 46 situated at the second axial end of the at least one power connector structure 36 is mateable with a compatible USB-type connector of an external power source in order to charge the rechargeable battery 19 of the portable, handheld, electronic device 4.

Preferably, the USB-type connector 46 of the portable, handheld, electronic device 4 situated at the second axial end of the at least one power connector structure 36 includes a first section 52 and a second section 54. The second section 54 is pivotally joined to the first section 52 and pivotable relative to the first section 52 between a first position and at least a second position. When the second section 54 is in the first position, the second section 54 resides substantially coplanarly with the first section 52 such that the USB-type connector 46 is in an unfolded state. When the second section 54 is in the second position, the second section 54 resides substantially non-coplanarly to the first section 52 such that the USB-type connector 46 is in an at least partially folded state.

Preferably, the at least one power connector structure 36 includes a pivot pin 60. Each of the first section 52 and the second section 54 of the USB-type connector 46 situated at the second axial end of the at least one power connector structure 36 is connected to the pivot pin 60 such that the second section 54 is pivotable with respect to the first section 52 about the pivot pin 60.

Preferably, the first section 52 of the USB-type connector 46 of the at least one power connector structure 36 includes a first electrical contact 56 mounted thereon, and the second section 54 of the USB-type connector 46 of the at least one power connector structure 36 includes a second electrical contact 58 mounted thereon. Even more preferably, the first section 52 of the USB-type connector 46 of the at least one power connector structure 36 includes a third electrical contact 78 mounted thereon, and at least one of the first section 52 and the second section 54 of the USB-type connector 46 of the at least one power connector structure 36 includes an electrical spring contact 80. The spring contact 80 electrically engages the second electrical contact 58 of the second section 54 and the third electrical contact 78 of the first section 52 to provide an electrical circuit therebetween when the second section 54 is at least in the first position and the USB-type connector 46 is at least in the unfolded state.

The housing 12 of the portable, handheld, electronic device 4 preferably includes a first wall 42 and a second wall 44 situated adjacent to the first wall 42. The first section 52 and the second section 54 of the USB-type connector 46 situated at the first axial end of the at least one power connector structure 36 preferably reside substantially coplanarly respectively with the first wall 42 and the second wall 44 of the housing 12 of the portable, handheld, electronic device 4 when the at least one power connector structure 36 is in the first position.

Preferably, each of the first wall 42 and the second wall 44 of the housing 12 of the portable, handheld, electronic device 4 has an outer surface, and each of the first section 52 and the second section 54 of the USB-type connector 46 has an outer surface. When the at least one power connector structure 36 is in the first position, and the second section 54 of the USB-type connector 46 is in the second position such that the USB-type connector 46 is in the at least partially folded state, the outer surface of the first section 52 resides substantially flush with the outer surface of the first wall 42 of the housing 12 of the portable, handheld, electronic device 4, and the outer surface of the second section 54 resides substantially flush with the outer surface of the second wall 44 of the housing 12 of the portable, handheld, electronic device 4.

In a preferred form of the portable, handheld, electronic device 4 of the present invention, the outer surface of the first wall 42 of the housing 12 of the portable, handheld, electronic device 4 is substantially perpendicular to the outer surface of the second wall 44 of the housing 12 of the portable, handheld, electronic device 4. When the second section 54 of the USB-type connector 46 is in the second position, the second section 54 preferably resides substantially perpendicularly to the first section 52 of the USB-type connector 46.

Preferably, the outer surface of the first wall 42 of the housing 12 of the portable, handheld, electronic device 4 has a first recess 38 formed therein, and the outer surface of the second wall 44 of the housing 12 of the portable, handheld, electronic device 4 has a second recess 40 formed therein. The first section 52 of the USB-type connector 46 and the second section 54 of the USB-type connector 46 of the at least one power connector structure 36 are respectively received by the first recess 38 formed in the outer surface of the first wall 42 of the housing 12 of the portable, handheld, electronic device 4 and the second recess 40 formed in the outer surface of second wall 44 of the housing 12 of the portable, handheld, electronic device 4 when the second section 54 is in the second position such that the USB-type connector 46 is in the at least partially folded state and when the at least one power connector structure 36 is in the first position.

The portable, handheld, electronic device 2 of the present invention may include structure to releasably hold the at least one power connector structure 36 to the housing 12 of the portable, handheld electronic device 4. More specifically, the first wall 42 of the housing 12 of the portable, handheld, electronic device 4 preferably includes one of a detent 92 and a recess 88, the second wall 44 of the housing 12 of the portable, handheld, electronic device 4 preferably includes one of a detent 92 and a recess 88, the first section 52 of the USB-type connector 46 of the at least one power connector structure 36 preferably includes one of a recess 88 and a detent 92, and the second section 54 of the USB-type connector 46 of the at least one power connector structure 36 preferably includes one of a recess 88 and a detent 92. When the at least one power connector structure 36 is in the first position, and the second section 54 of the USB-type connector 46 is in the second position such that the USB-type connector 46 is in the at least partially folded state, the one of the recess 88 and the detent 92 of the first section 52 engages the one of the detent 92 and the recess 88 of the first wall 42 of the housing 12 of the portable, handheld, electronic device 4, and the one of the recess 88 and the detent 92 of the second section 54 engages the one of the detent 92 and the recess 88 of the second wall 44 of the housing 12 of the portable, handheld, electronic device 4 to thereby releasably secure the first section 52 of the USB-type connector 46 to the first wall 42 of the housing 12 of the portable, handheld, electronic device 4 and the second section 54 of the USB-type connector 46 to the second wall 44 of the housing 12 of the portable, handheld, electronic device 4.

Preferably, each of the first section 52 and the second section 54 of the USB-type connector 46 of the at least one power connector structure 36 of the portable, handheld, electronic device 4 includes an orientation shoulder 71 formed thereon. The orientation shoulders 71 allow the USB-type connector 46, when in the unfolded state, to be mateable with (e.g., insertable into) the compatible USB-type connector of the external power source only when the unfolded USB-type connector 46 is in a particular orientation relative to the compatible USB-type connector of the external power source.

In another form of the present invention, the first section 52 and the second section 54 of the USB-type connector 46 of the portable, handheld, electronic device 4 respectively include a first portion 62 and a second portion 68, the first portion 62 of the first section 52 engaging the second portion 68 of the second section 54. Furthermore, each of the engaging first and second portions 62, 68 of the first and second sections 52, 54 of the USB-type connector 46 has one of at least one protrusion 84 and at least one recess 82. The at least one protrusion 84 is at least partially receivable by the at least one recess 82 to selectively maintain the second section 54 relative to the first section 52 in at least one of the first position and the second position such that the USB-type connector 46 is selectively maintained in at least one of the unfolded state and the. at least partially folded state.

The portable, handheld, electronic device 4 of the present invention may further include electronic circuitry 18, the electronic circuitry 18 being situated within the internal cavity of the housing 12. Also, the at least one power connector structure 36 may include electrical wires 48 joining the at least one power connector structure 36 to the electronic circuitry 18 situated within the internal cavity of the housing 12 of the portable, handheld, electronic device 4.

Furthermore, the portable, handheld, electronic device 4 of the present invention may include a microphone 13, the microphone 13 being mounted on the housing 12.

It should be realized that, although the foldable USB-type connector portion 46 is preferably formed as a male connector, the connector portion 46 may be formed as a female connector to mate with a compatible USB-type male connector of an external power source.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A wireless earphone or headphone assembly for communicating wirelessly with an external audio source, the external audio source generating an output signal, which comprises:
a control unit, the control unit having a housing, the housing defining an internal cavity;
electronic circuitry for receiving the output signal generated by the external audio source and generating a speaker signal in response thereto, at least a portion of the electronic circuitry being situated within the internal cavity of the control unit or mounted on the housing of the control unit;
at least one ear piece, the at least one ear piece including a housing having an exterior wall, the ear piece housing defining an internal cavity;
at least one speaker, the at least one speaker being situated at least partially within the internal cavity of the ear piece housing and being electrically coupled to the electronic circuitry, the speaker being responsive to the speaker signal of the electronic circuitry and generating an audible sound in response thereto;
at least one battery, the at least one battery being situated at least partially within at least one of the internal cavity of the ear piece housing and the internal cavity of the control unit housing, the at least one battery being in electrical communication with the electronic circuitry;
at least one power connector plug, the at least one power connector plug being releasably mounted on the housing of the control unit and being extendable therefrom, the at least one power connector plug having a first axial end coupled to the control unit, and a second axial end situated opposite from the first axial end; and
a USB-type male connector, the USB-type male connector being situated at the second axial end of the at least one power connector plug;
wherein the at least one power connector plug is positionable relative to the housing of the control unit in a first position in which the at least one power connector plug is situated in close proximity to the housing of the control unit, and in at least a second position in which the at least one power connector plug extends outwardly from the housing of the control unit; and
wherein, when in the second position, the USB-type male connector situated at the second axial end of the at least one power connector plug is mateable with a compatible USB-type female connector of an external power source in order to charge the at least one battery of the wireless earphone or headphone assembly.

2. A wireless earphone or headphone assembly as defined by claim 1, wherein the USB-type male connector situated at the second axial end of the at least one power connector plug includes a first section and a second section, the second section being pivotally joined to the first section and pivotable relative to the first section between a first position and at least a second position;
wherein, when the second section is in the first position, the second section resides substantially coplanarly with the first section such that the USB-type male connector is in an unfolded state; and
wherein, when the second section is in the second position, the second section resides substantially non-coplanarly to the first section such that the USB-type male connector is in an at least partially folded state.

3. A wireless earphone or headphone assembly as defined by claim 2, wherein the at least one power connector plug includes a pivot pin, each of the first section and the second section of the USB-type male connector situated at the second axial end of the at least one power connector plug being connected to the pivot pin such that the second section is pivotable with respect to the first section about the pivot pin.

4. A wireless earphone or headphone assembly as defined by claim 2, wherein the first section of the USB-type male connector of the at least one power connector plug includes a first electrical contact mounted thereon; and
wherein the second section of the USB-type male connector of the at least one power connector plug includes a second electrical contact mounted thereon.

5. A wireless earphone or headphone assembly as defined by claim 4, wherein the first section of the USB-type male connector of the at least one power connector plug includes a third electrical contact mounted thereon; and
wherein at least one of the first section and the second section of the USB-type male connector of the at least one power connector plug includes an electrical spring contact, the spring contact electrically engaging the second electrical contact of the second section and the third electrical contact of the first section to provide an electrical circuit therebetween when the second section is at least in the first position and the USB-type male connector is at least in the unfolded state.

6. A wireless earphone or headphone assembly as defined by claim 2, wherein the housing of the control unit includes a first wall and a second wall situated adjacent to the first wall; and
wherein the first section and the second section of the USB-male type connector situated at the first axial end of the at least one power connector plug reside substantially coplanarly respectively with the first wall and the second wall of the housing of the control unit when the at least one power connector plug is in the first position.

7. A wireless earphone or headphone assembly as defined by claim 6, wherein each of the first wall and the second wall of the housing of the control unit has an outer surface;
wherein each of the first section and the second section of the USB-type male connector has an outer surface; and
wherein, when the at least one power connector plug is in the first position, and the second section of the USB-type male connector is in the second position such that the USB-type male connector is in the at least partially folded state, the outer surface of the first section resides substantially flush with the outer surface of the first wall of the housing of the control unit, and the outer surface of the second section resides substantially flush with the outer surface of the second wall of the housing of the control unit.

8. A wireless earphone or headphone assembly as defined by claim 7, wherein the outer surface of the first wall of the housing of the control unit is substantially perpendicular to the outer surface of the second wall of the housing of the control unit; and
wherein, when the second section of the USB-type male connector is in the second position, the second section resides substantially perpendicularly to the first section of the USB-type male connector.

9. A wireless earphone or headphone assembly as defined by claim 7, wherein the outer surface of the first wall of the housing of the control unit has a first recess formed therein;
wherein the outer surface of the second wall of the housing of the control unit has a second recess formed therein; and
wherein the first section of the USB-type male connector and the second section of the USB-type male connector of the at least one power connector plug are respectively received by the first recess formed in the outer surface of the first wall of the housing of the control unit and the second recess formed in the outer surface of second wall of the housing of the control unit when the second section is in the second position such that the USB-type male connector is in the at least partially folded state and when the at least one power connector plug is in the first position.

10. A wireless earphone or headphone assembly as defined by claim 7, wherein the first wall of the housing of the control unit includes one of a detent and a recess;
wherein the second wall of the housing of the control unit includes one of a detent and a recess;
wherein the first section of the USB-type male connector of the at least one power connector plug includes one of a recess and a detent;
wherein the second section of the USB-type male connector of the at least one power connector plug includes one of a recess and a detent; and
wherein, when the at least one power connector plug is in the first position, and the second section of the USB-type male connector is in the second position such that the USB-type male connector is in the at least partially folded state, the one of the recess and the detent of the first section engages the one of the detent and the recess of the first wall of the housing of the control unit, and the one of the recess and the detent of the second section engages the one of the detent and the recess of the second wall of the housing of the control unit to thereby releasably secure the first section of the USB-type male connector to the first wall of the housing of the control unit and the second section of the USB-type male connector to the second wall of the housing of the control unit.

11. A wireless earphone or headphone assembly as defined by claim 2, wherein each of the first section and the second section of the USB-type male connector of the at least one power connector plug includes an orientation shoulder formed thereon, the orientation shoulders allowing the USB-type male connector, when in the unfolded state, to be mateable with the compatible USB-type female connector of the external power source only when the unfolded USB-type male connector is in a particular orientation relative to the compatible USB-type female connector of the external power source.

12. A wireless earphone or headphone assembly as defined by claim 2, wherein the first section and the second section of the USB-type male connector respectively include a first portion and a second portion, the first portion of the first section engaging the second portion of the second section; and
wherein each of the engaging first and second portions of the first and second sections of the USB-type male connector has one of at least one protrusion and at least one recess, the at least one protrusion being at least partially receivable by the at least one recess to selectively maintain the second section relative to the first section in at least one of the first position and the second position such that the USB-type male connector is selectively maintained in at least one of the unfolded state and the at least partially folded state.

13. A wireless earphone or headphone assembly as defined by claim 1, wherein the at least one power connector plug includes electrical wires joining the first axial end of the at least one power connector plug to the electronic circuitry situated within the internal cavity of the housing of the control unit.

14. A wireless earphone or headphone assembly as defined by claim 1, wherein the housing of the control unit further includes a first section and a second section joined to the first section, the first section and the second section together defining the internal cavity of the housing of the control unit.

15. A wireless earphone or headphone assembly as defined by claim 1, which further comprises:
a microphone, the microphone being mounted on the housing of the control unit.

16. A portable, handheld, electronic device, which comprises:
a housing, the housing defining an internal cavity;
a rechargeable battery situated within the internal cavity of the housing;
at least one power connector structure, the at least one power connector structure being mounted on the housing of the portable, handheld, electronic device and being extendable therefrom, the at least one power connector structure having a first axial end joined to the housing or extending into the internal cavity defined by the housing of the portable, handheld, electronic device, and a second axial end situated opposite from the first axial end; and
a USB-type connector, the USB-type connector being situated at the second axial end of the at least one power connector structure;
wherein the at least one power connector structure is positionable relative to the housing of the portable, handheld, electronic device in a first position in which the at least one power connector structure is situated in close proximity to the housing of the portable, handheld, electronic device, and in at least a second position in which the at least one power connector structure extends outwardly from the housing of the portable, handheld, electronic device; and
wherein, when in the second position, the USB-type connector situated at the second axial end of the at least one power connector structure is mateable with a compatible USB-type connector of an external power source in order to charge the rechargeable battery of the portable, handheld, electronic device.

17. A portable, handheld, electronic device as defined by claim 16, wherein the USB-type connector situated at the second axial end of the at least one power connector structure includes a first section and a second section, the second section being pivotally joined to the first section and pivotable relative to the first section between a first position and at least a second position;
wherein, when the second section is in the first position, the second section resides substantially coplanarly with the first section such that the USB-type connector is in an unfolded state; and
wherein, when the second section is in the second position, the second section resides substantially non-coplanarly to the first section such that the USB-type connector is in an at least partially folded state.

18. A portable, handheld, electronic device as defined by claim 17, wherein the at least one power connector structure includes a pivot pin, each of the first section and the second section of the USB-type connector situated at the second axial end of the at least one power connector structure being connected to the pivot pin such that the second section is pivotable with respect to the first section about the pivot pin.

19. A portable, handheld, electronic device as defined by claim 17, wherein the first section of the USB-type connector of the at least one power connector structure includes a first electrical contact mounted thereon; and
wherein the second section of the USB-type connector of the at least one power connector structure includes a second electrical contact mounted thereon.

20. A portable, handheld, electronic device as defined by claim 19, wherein the first section of the USB-type connector of the at least one power connector structure includes a third electrical contact mounted thereon; and
wherein at least one of the first section and the second section of the USB-type connector of the at least one power connector structure includes an electrical spring contact, the spring contact electrically engaging the second electrical contact of the second section and the third electrical contact of the first section to provide an electrical circuit therebetween when the second section is at least in the first position and the USB-type connector is at least in the unfolded state.

21. A portable, handheld, electronic device as defined by claim 17, wherein the housing includes a first wall and a second wall situated adjacent to the first wall; and
wherein the first section and the second section of the USB-type connector situated at the first axial end of the at least one power connector structure reside substantially coplanarly respectively with the first wall and the second wall of the housing of the portable, handheld, electronic device when the at least one power connector structure is in the first position.

22. A portable, handheld, electronic device as defined by claim 21, wherein each of the first wall and the second wall of the housing of the portable, handheld, electronic device has an outer surface;
wherein each of the first section and the second section of the USB-type connector has an outer surface; and
wherein, when the at least one power connector structure is in the first position, and the second section of the USB-type connector is in the second position such that the USB-type connector is in the at least partially folded state, the outer surface of the first section resides substantially flush with the outer surface of the first wall of the housing of the portable, handheld, electronic device, and the outer surface of the second section resides substantially flush with the outer surface of the second wall of the housing of the portable, handheld, electronic device.

23. A portable, handheld, electronic device as defined by claim 22, wherein the outer surface of the first wall of the housing of the portable, handheld, electronic device is substantially perpendicular to the outer surface of the second wall of the housing of the portable, handheld, electronic device; and
wherein, when the second section of the USB-type connector is in the second position, the second section resides substantially perpendicularly to the first section of the USB-type connector.

24. A portable, handheld, electronic device as defined by claim 22, wherein the outer surface of the first wall of the housing of the portable, handheld, electronic device has a first recess formed therein;
wherein the outer surface of the second wall of the housing of the portable, handheld, electronic device has a second recess formed therein; and
wherein the first section of the USB-type connector and the second section of the USB-type connector of the at least one power connector structure are respectively received by the first recess formed in the outer surface of the first wall of the housing of the portable, handheld, electronic device and the second recess formed in the outer surface of second wall of the housing of the portable, handheld, electronic device when the second section is in the second position such that the USB-type connector is in the at least partially folded state and when the at least one power connector structure is in the first position.

25. A portable, handheld, electronic device as defined by claim 22, wherein the first wall of the housing of the portable, handheld, electronic device includes one of a detent and a recess;
wherein the second wall of the housing of the portable, handheld, electronic device includes one of a detent and a recess;
wherein the first section of the USB-type connector of the at least one power connector structure includes one of a recess and a detent;
wherein the second section of the USB-type connector of the at least one power connector structure includes one of a recess and a detent; and
wherein, when the at least one power connector structure is in the first position, and the second section of the USB-type connector is in the second position such that the USB-type connector is in the at least partially folded state, the one of the recess and the detent of the first section engages the one of the detent and the recess of the first wall of the housing of the portable, handheld, electronic device, and the one of the recess and the detent of the second section engages the one of the detent and the recess of the second wall of the housing of the portable, handheld, electronic device to thereby releasably secure the first section of the USB-type connector to the first wall of the housing of the portable, handheld, electronic device and the second section of the USB-type connector to the second wall of the housing of the portable, handheld, electronic device.

26. A portable, handheld, electronic device as defined by claim 17, wherein each of the first section and the second section of the USB-type connector of the at least one power connector structure includes an orientation shoulder formed thereon, the orientation shoulders allowing the USB-type connector, when in the unfolded state, to be mateable with the compatible USB-type connector of the external power source only when the unfolded USB-type connector is in a particular orientation relative to the compatible USB-type connector of the external power source.

27. A portable, handheld, electronic device as defined by claim 17, wherein the first section and the second section of the USB-type connector respectively include a first portion and a second portion, the first portion of the first section engaging the second portion of the second section; and
wherein each of the engaging first and second portions of the first and second sections of the USB-type connector has one of at least one protrusion and at least one recess, the at least one protrusion being at least partially receivable by the at least one recess to selectively maintain the second section relative to the first section in at least one of the first position and the second position such that the USB-type connector is selectively maintained in at least one of the unfolded state and the at least partially folded state.

28. A portable, handheld, electronic device as defined by claim 16, which further comprises:
electronic circuitry, the electronic circuitry being situated within the internal cavity of the housing;
wherein the at least one power connector structure includes electrical wires joining the at least one power connector structure to the electronic circuitry situated within the internal cavity of the housing of the portable, handheld, electronic device.

29. A portable, handheld, electronic device at defined by claim 16, which further comprises:
a microphone, the microphone being mounted on the housing.
